(19) United States
(12) Patent Application Publication
(10) Pub. No.: US 2013/0304886 A1
(43) Pub. Date: Nov. 14, 2013

(54) LOAD BALANCING FOR MESSAGING TRANSPORT

(71) Applicants: Avraham Harpaz, Haifa (IL); Nir Naaman, Haifa (IL); Idan Zach, Nesher (IL)

(72) Inventors: Avraham Harpaz, Haifa (IL); Nir Naaman, Haifa (IL); Idan Zach, Nesher (IL)

(73) Assignee: INTERNATIONAL BUSINESS MACHINES CORPORATION, Armonk, NY (US)

(21) Appl. No.: 13/470,361

(22) Filed: May 14, 2012

(51) Int. Cl. H04L 12/24

(52) U.S. Cl. CPC H04L 41/00
USPC 709/223

(57) ABSTRACT

A method of routing dependent messages sent from a source node. The method comprises routing a plurality of messages including a plurality of dependent messages from a source node for processing by a group of a plurality of processing nodes, optionally while managing a failure recovery mechanism and complying with message dependencies. Each message having a weight, each dependent message is routed while at least one dependency thereof is complied with, acquiring a plurality of acknowledge notifications to at least some of the plurality of messages from the plurality of processing nodes, calculating, at the source node using a processor, a message load of each of the plurality of processing nodes according to the weight of respective messages of plurality of messages which are sent thereto and respective acknowledge notifications of the plurality of acknowledge notifications which are sent therefrom. The routing is performed according to the respective message load.

### BACKGROUND

The present invention, in some embodiments thereof, relates to load balancing and, more specifically, but not exclusively, to load balancing for messaging transport with support for failure recovery and/or message dependencies.

Load balancing is a computer networking methodology to distribute workload across multiple computing nodes, for example computer cluster(s), central processing nodes, servers, or other resources, to increase resource utilization and throughput and to reduce response time and overload. Using multiple components with load balancing, instead of a single component, may increase reliability through redundancy. The load balancing service is usually provided by dedicated software or hardware, such as a multilayer switch or a domain name system (DNS) server.

A common application of load balancing is to provide an internet service via multiple servers. Commonly, load-balanced systems include web sites, Internet Relay Chat networks, high-bandwidth file transfer protocol (FTP) sites, network news transfer protocol (NNTP) servers and domain name system (DNS) servers.

### SUMMARY

According to some embodiments of the present invention, there is provided a computerized method of routing messages sent from a source node to a processing node. The method comprises routing a plurality of messages including a plurality of dependent messages from a source node for processing by any of a group of a plurality of processing nodes, each the message having a weight, each the dependent message being routed while at least one dependency thereof is complied with, acquiring a plurality of acknowledge notifications to at least some of the plurality of messages from the plurality of processing nodes, and calculating, at the source node using a processor, a message load of each one of the plurality of processing nodes according to the weight of respective messages of the plurality of messages which are sent thereto and respective acknowledge notifications of the plurality of acknowledge notifications which are sent therefrom. The routing is performed according to respective the message load.

According to some embodiments of the present invention, there is provided a computerized method of recovering dependent messages sent from a source node to one or more processing nodes. The method comprises routing a plurality of messages including a plurality of dependent messages from a source node having a processor for processing by any of a plurality of processing nodes, acquiring a plurality of acknowledge notifications each sent in response to the processing of one of the plurality of messages from the plurality of processing nodes, identifying, using the processor, at least one unprocessed dependent message from of the plurality of messages and a failed processing node of the plurality of processing nodes according to an analysis of the plurality of acknowledge notifications, and rerouting the at least one unprocessed dependent message for processing by a member of the plurality of processing nodes which is not the failed processing node while at least one dependency thereof is complied with.

According to some embodiments of the present invention, there is provided a load balancing system that comprises a processor, a routing module which routes a plurality of messages including a plurality of dependent messages for processing by any of a plurality of processing nodes, each the message having a weight and being transmitted from a source node each the dependent message being routed while at least one dependency thereof is complied with, and an interface that acquires a plurality of acknowledge notifications, each sent in response to the processing of one of the plurality of messages by one of the plurality of processing nodes. The routing module calculates a message load of each one of the plurality of processing nodes at the source using the processor according to the weight of respective of the plurality of messages and the plurality of acknowledge notifications. The routing module performs the routing the plurality of messages according to respective the message load while respective the at least one dependency of each the dependent message is complied with.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of source node(s), a plurality of processing nodes, optionally independent from one another, and/or destination node(s), which communicate according to some embodiments of the present invention;

FIG. 2 is a schematic illustration of different layers that deal with message routing and processing in a source node 101 and a processing node, according to some embodiments of the present invention;

FIGS. 3A and 3B are two parts of a flowchart of a process of balancing the load of processing nodes by a source node, while managing a failure recovery mechanism and complying with message dependencies, according to some embodiments of the present invention; and

FIG. 4 is a schematic illustration depicting exemplary nodes which implement a load balancing scheme pertaining to processing messages of a financial markets trading application, according to some embodiments of the present invention.

### DETAILED DESCRIPTION

The present invention, in some embodiments thereof, relates to load balancing and, more specifically, but not exclusively, to load balancing for messaging transport with support for failure recovery and/or message dependencies.

According to some embodiments of the present invention, there are provided methods and systems of balancing the load of a plurality of processing nodes, such as servers, at a source node which transmits messages, including dependent messages, according to an analysis of a plurality of acknowledge notifications which are received from the processing nodes in real time. The processed messages may be forwarded from the processing nodes to one or more destination nodes. In use, transmitted dependent messages are optionally weighted and documented so as to identify what is the current load of each one of the processing nodes. The acknowledge notifications are received and used to confirm compliance with the dependencies of the dependent messages and to update the load of the processing nodes, indicating that respective messages have been received or even processed and optionally forwarded to the destination directly from the processing nodes.

Optionally, the messages have dependencies, such as result based dependencies and time based dependencies. The dependency types are exemplified below.

For example, a history queue is locally managed to log which messages have been sent and in what order. Such a history queue may be used for high availability and/or recovery. The history queue may also by used for verifying that a dependent message is sent only after the history queue indicates that one or more respective messages have been acknowledged by the processing nodes and/or by a certain processing node. In another example, processing results are monitored and logged to verify the dependencies.

According to some embodiments of the present invention, there are provided methods and systems of recovering messages sent from a source node to processing unit(s) by acquiring acknowledge notifications sent in response to the processing of messages from processing nodes and identifying unprocessed message(s) and failed processing node(s) according to an analysis of the acknowledge notifications. This allows rerouting the unprocessed message(s) for processing by active processing nodes while still complying with their dependencies. Optionally, the methods and systems of recovering messages are implemented as part of the aforementioned methods and systems of load balancing. Dependent messages are routed according to their dependencies both during normal operation as well as during a recovery from a failure. As a result, these embodiments improve both the performance and the high-availability services significantly, and handle message dependencies properly.

Optionally, the systems and methods present a messaging transport layer that provides efficient combination of load balancing with failure recovery and support for message dependencies. These systems and methods are used to balance the load among processing nodes which process dependent messages of high throughput and low latency applications such as those found in financial markets. Such load balancing assigns each processing node a total work which is proportional to its load, thereby optimizes resources usages, for example minimizes execution time. In addition, such load balancing provides a reliable service even in the event of failures of the processing nodes.

The solutions outlined above and described below overcome drawbacks of known systems by allowing the source node to serve new messages without waiting for responses of previous last messages and dealing with failures on demand. As further described below, unprocessed messages which have been transmitted to failed processing nodes are retransmitted to processing nodes.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

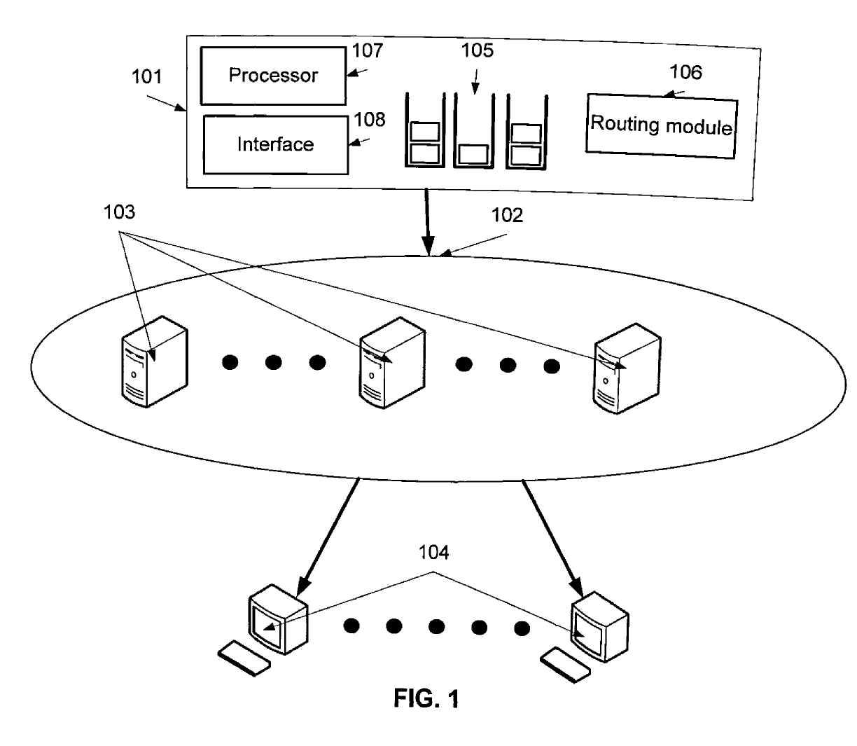

Reference is now made to FIG. 1, which is a schematic illustration of one or more source nodes 101, for example server(s) hosting one or more web applications, a plurality of processing nodes 102 (each numerated with 103), optionally independent from one another, which may be clustered and/or distributed, and/or one or more destination nodes 104, according to some embodiments of the present invention. As used herein a node is an entity having a processor 107 and connected to a computer network, such as the internet or an Ethernet, for example a desktop, a server, a laptop, a tablet, a Smartphone, and/or cluster of nodes. The one or more source nodes 101, for brevity referred to herein as a source node 101, use the processing nodes 102 for processing messages including dependent messages, such as orders, instructions and/or the like, and logs acknowledge notifications received therefrom for monitoring message processing load in each one of the processing nodes. As used herein, an acknowledge notification is a message indicative of a completion of a processing of a message received from the source node 101. This monitoring allows the source node 101 to route messages to processing nodes 103 based on their availability while complying with the dependencies of each dependent message. The routing is optionally performed via an interface 108, such as a network interface card (NIC).

The number of used processing nodes 103 may be dynamically adjusted based on the load, for example, periodically during the day according to estimated and/or calculated load.

The source node 101, for example a routing module 106 thereof, monitors dependencies between messages. In such a manner, dependent messages may be routed to the destination node 104 via any of the independent processing nodes 103 while complying with the dependencies of the dependent messages even thought the independent processing nodes 103 may not be aware of the dependencies. For brevity, m₁, m₂, m₃, . . . denotes a sequence of messages and mⱼ→mᵢ denotes message mⱼ which depends on message mᵢ if message mⱼ should or must be processed after message mᵢ and dep(mⱼ)={mᵢ|i<j and mⱼ→mᵢ} denotes the set of messages that message m₃ depends on.

Optionally, a dependency of a message is a time-based dependency: Two messages mⱼ→mᵢ, must be processed one after the other. In other words, message mⱼ must be processed after the processing of dep(mⱼ) was completed.

Optionally, a dependency of a message is a result-based dependency where message mⱼ depends on message mᵢ (mⱼ→mᵢ). A prerequisite for the processing of message mⱼ is the result from the processing of message mᵢ. That is, message mⱼ should be either processed by the same server of message mᵢ or the server of message mⱼ should receive the result of mᵢ before the processing of mⱼ. It should be noted that each message may have to comply with dependencies of both types.

If the dependent message has a time-based dependency and the acknowledge notification for the message it depends on is available, the dependency is considered as complied with. If the dependent message has a result-based dependency and the result for the message it depends on is available, the dependency is considered as complied with. If all the dependencies of message mⱼ are complied with, then message mⱼ could be sent to any processing unit. If all the messages in dep(mⱼ) which have not been acknowledged were sent to the same processing unit and the reliable messaging layer provides first in first out ordering, then message mⱼ could be sent to the same processing unit with no need to wait for acknowledge notification of any message in dep(mⱼ).

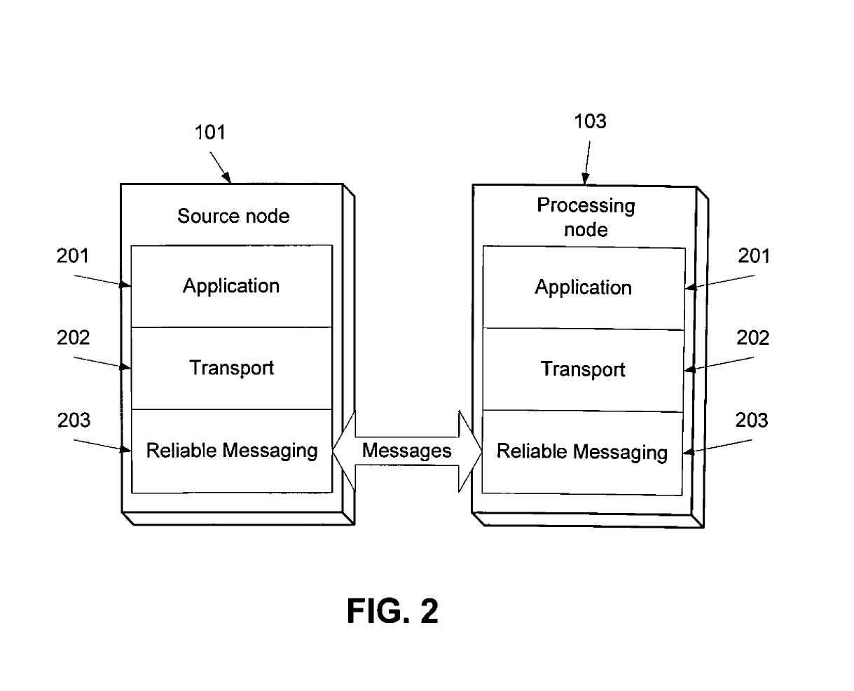

Reference is now made to FIG. 2, which is a schematic illustration of the different layers 201, 202, 203, that deal with message processing in the source node 101 and in any of the processing nodes 103, according to some embodiments of the present invention. Each of the nodes includes a reliable messaging layer 203, which is responsible for consistent data delivery and communication between the source node 101 and the processing node 103. It should be noted that the roles of transport and application layers 202, 201 are different in the source node 101 and processing node 103. The above three layers may be combined into a single layer or two layers.

The reliable messaging layer 203 delivers messages and acknowledge notifications, to the transport layer 202 and sends messages and acknowledge notifications submitted by the transport layer 202. The reliable messaging layer 203 of the source node 101 receives messages and sends messages to one or more processing units, which optionally forward processed messages to destination nodes(s) 104, optionally in a first in first out (FIFO) order. The application layer 201 implements one or more application logic(s) and uses the transport layer 202 for communication. The transport layer 202 of the source node 101 manages load balancing, for example according to logic which is implemented by the routing module 106. This layer optionally manages the dependencies between messages and/or failure recovery mechanism, for example as described below. The transport layer 202 receives messages that should be sent from the application layer 201 and delivers received messages to the application layer 201.

The transport layer 202 of the source node 101 uses the reliable messaging layer 203 to send reliably messages and receive acknowledgment notifications. In such a manner, the application layer 201 of the source node 101 is released from load balancing tasks.

In use, the processing nodes 103 may fail to process received messages, for example due to hardware, software or communication malfunctions. When a processing node 103 fails, the messages that were sent thereto may be lost. In order to recover the transmission(s) of the lost messages, for example by resending them to an operative processing node 103, a failure recovery mechanism is optionally implemented. In such a manner, applications in which all the messages must be processed, optionally only once, and/or applications in which all message dependencies must be respected may be executed on the nodes 101, 103. An example for such applications are financial markets trading applications in which each message may represent at least a part of a trading request, such as buy or sale order. In this example, the source node 101 is a broker client terminal and the processing nodes 103 are order routers that process and direct orders to an execution venue, for example as exemplified below.

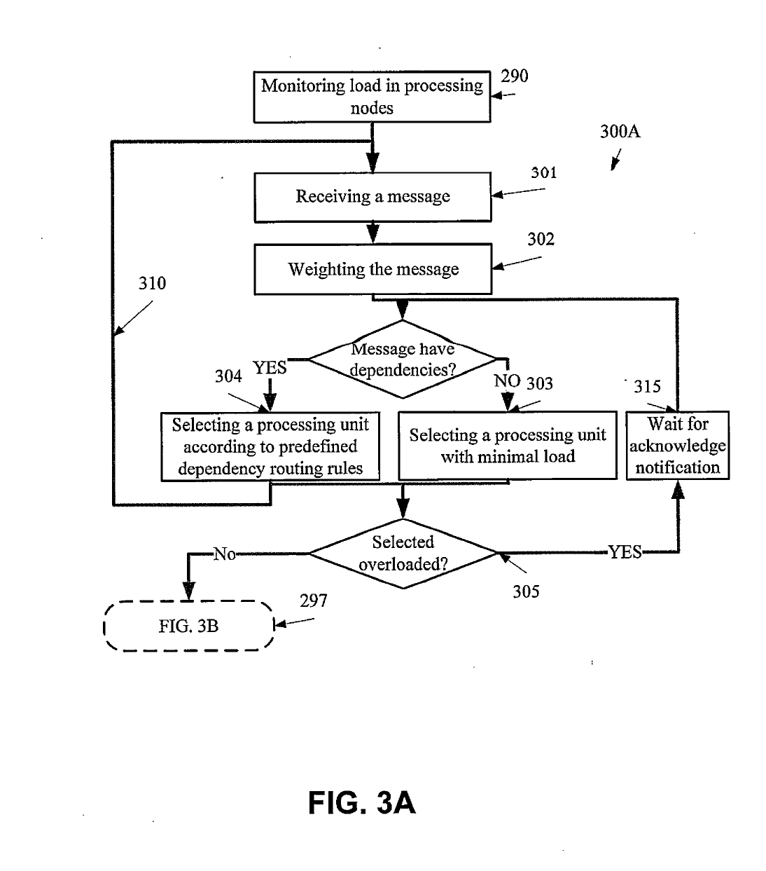

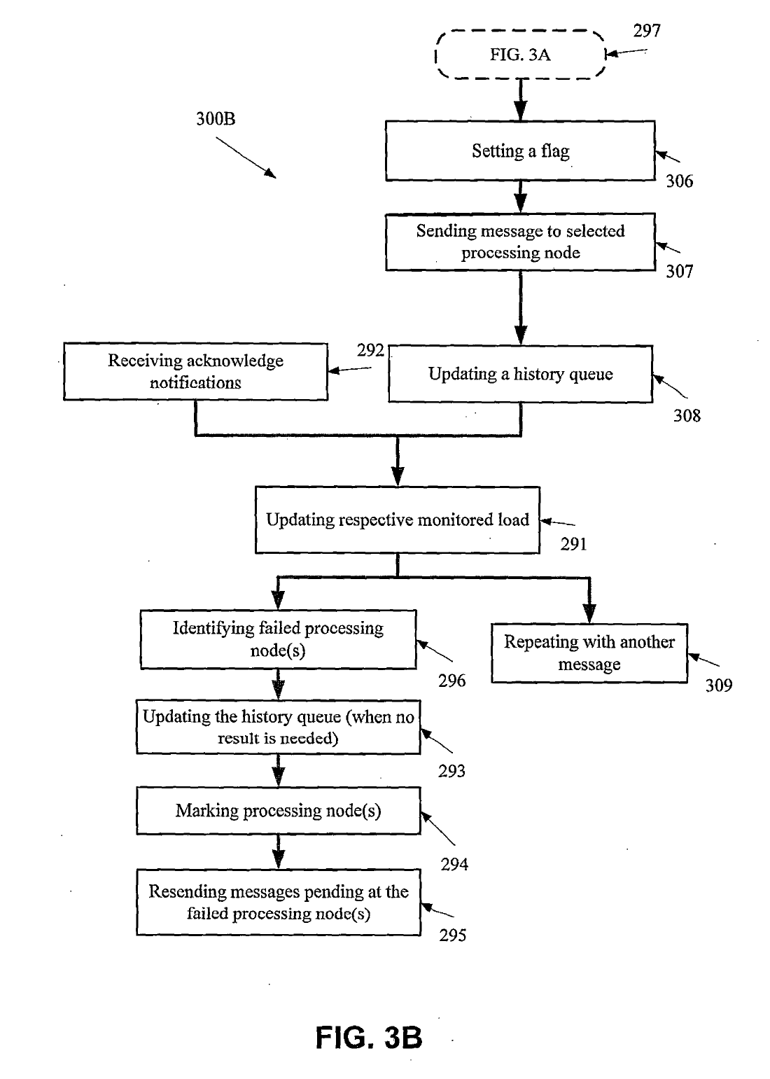

Reference is now also made to FIGS. 3A and 3B, which are two parts 300A, 300B of a flowchart of a process of balancing the load of a plurality of processing nodes, such as 103, by a source node, such as 101, while managing a failure recovery mechanism and assuring a compliance of rerouted dependent messages with their dependencies, according to some embodiments of the present invention.

Reference is now made to FIG. 3A. The source node 101, for example the routing module 106, maintains a list of processing nodes 103, for example unique identifiers thereof, such as addresses. Optionally, as shown at 290, an estimated load value is monitored and updated per processing node 103, for example as described below.

When a message is received, for example from a hosted application, as shown at 301, computational resource(s), for instance estimated processing time, pertaining to the processing of the message by a processing node 103 is calculated, for example as a message weight, as shown at 302. The calculation is optionally based on one or more message properties, such as message type, message length (i.e. in bytes) and/or the like.

As shown at 303, if the message has no dependencies, a processing node 103 with a minimal load among the processing nodes 103 is selected. The load of each processing node 103 is optionally calculated according to weight(s) of message(s) which have been sent thereto and for which no acknowledge notification(s) has been received, for example as described below. Optionally, overloaded processing nodes 103 are automatically ignored. As used herein, an overloaded processing node 103 is a processing node 103 that its current load is higher than a maximum capacity value, for example a processing node 103 for which the sum of weights of unacknowledged messages that were sent thereto is greater or equal to a respective maximal capacity value. It should be noted that selecting a processing node 103 with a minimal load is an exemplary rule that may be replaced and/or added to other rule(s).

As shown at 304, if the dependent message has dependencies on other messages, the processing node 103 is selected according to predefined dependency routing rules. These rules may be provided per dependent message and/or dependency, optionally by an originating application. The dependency routing rule may depend on messages previously submitted by the application. Example for such rules are as follows:
If all completely processed messages in dep(mⱼ) are acknowledged, a processing node 103 with the minimal load among active processing nodes 103 (i.e. not overloaded) is selected else either queue message mⱼ in a pending queue until respective acknowledge notification(s) are received for all the respective dependent message(s) or select a processing node 103 to which all unacknowledged dependent messages were sent. If the pending dependent messages were sent to different processing nodes 103 than mⱼ is queued. Optionally, a decision whether to queue a message depends on the load of the processing node(s).
If the dependent message has dependencies on messages sent to a common processing node 103, and that processing node 103 is not overloaded, the common processing node 103 is selected.
Selecting a processing node 103 with a minimal load in relation to a processing node 103 which has received most of the result-based dependent messages related to the message.

Optionally, if the dependent message has pending dependency on a message that was not acknowledged yet, the message is added to a pending queue and a new message may be taken, as shown at 310. In such an embodiment, if sending a message does not violate the routing rules of the messages in the pending queue then a message may be fully processed and sent out. Optionally, messages from the pending queue are processed in a first in first out (FIFO) manner. The source node 101 may decide to block the processing of new messages that are submitted by the application if the size of the pending queue grows above a certain limit.

Optionally, the dependent message is attached with tags of result-based dependent messages which are related thereto and not been sent to the selected processing node 103.

Optionally, as shown at 305, the source node verifies that the selected processing node 103 is not overloaded. The verification is optionally performed by verifying that the amount of messages at the selected processing node 103 and/or the sum of weights of messages, which are sent to the selected processing node 103 and for which no acknowledge notification was received at the source node 101 does not cross a limit threshold. For brevity, these messages are referred to herein as pending messages.

The limit threshold may differ from one processing node 103 to another. The limit threshold is optionally defined by a value referred to herein as a weighted window size. In such embodiments, before a certain message is sent to a processing node 103, the source node verifies that the total weight of pending messages for the processing node 103, including the weight of the certain message, is not greater than its maximum window size. A relatively small window increases latency as the pipeline is too short and a relatively large window leads to a large buffering and hence reduces the effectiveness of load balancing and increases the number of pending messages which have to be resent in case of a failure. Optionally, the window's size is tuned either manually or automatically to improve load balancing with minimal latency.

Optionally, as shown at 315, if the selected processing node 103 is overloaded, the source node 101 waits to receive an acknowledge notification from any of the processing nodes 103. Optionally, once the acknowledge notification is received, the dependencies of the message are tested again to check if all the dependencies of the message are already complied. Then, a processing node is selected either according to a minimal load among the processing nodes 103, as shown at 303, (if the message has dependencies) or according to predefined dependency routing rules, as shown at 304 (if the message does not have dependencies). Similarly, if all processing nodes 103 are overloaded, the source node 101 waits for an acknowledge notification from any processing node 103 and then either 303 or 304 are performed, depending on nature of the message (have dependencies or does not have dependencies).

For the case the selected processing node 103 is not overloaded, as shown at 297, reference is now made to FIG. 3B. Optionally, as shown at 306, for each message the source node 101 sets a flag, referred to herein as a result-requested flag, which indicates whether a result should be returned along with the acknowledge of this message. The source node 101 may define a type of a required result. In such embodiments, the message may be considered as acknowledged or unacknowledged based on the result.

Now, as shown at 307, the message is sent to the selected processing node 103. The source node 101, for example the routing module 106, stores the message with a processing node 103 identifier, in a queue, referred to herein a history queue, for example as shown at 308. The history queue allows routing messages which comply with their dependencies and/or identifying processing failure of one of the processing nodes 103.

Optionally, as shown at 291, the source node 101 updates the estimated current load value of the selected processing node 103. The estimated current load value is optionally a sum of the weights of the respective pending messages including the weight of the next message to be sent. If the new current load value is greater than or equal to the maximal capacity of the processing node 103, for example defined by the window size, the processing node 103 is marked as overloaded. Optionally, as described above, once a processing node 103 completes the processing of a message, it responds with an acknowledge notification to the source node 101. As shown at 309, another message is received and the process depicted in blocks 301-308 and 291 is repeated for another message that is sent from the source node 101 to the processing nodes 102 so that the process may be repeated for all messages sent from the source node 101 to the processing nodes 102.

When the source node receives the acknowledge notification it updates the load value of the respective processing node by reducing the weight of the processed message from the current load value. Optionally, a list documenting the pending message of the respective processing node is updated.

As shown at 292, if the acknowledge notification does not contain a result, for example the respective message is not marked with result requested flag, the source node 101 removes the message from the history queue, as shown at 293. In the case a result is included, the source node 101 marks the respective message as processed and adds the result of the processing without removing the respective record from the history queue.

Optionally, the source node is designed to identify when a processing node 103 fails, as shown at 296. This identification may be determined by measuring the time after sending a message to a processing node 103. If no acknowledge notification is received for a certain period, and optionally for each of a certain number of messages, the processing node 103 is identified as failed. It should be noted that failure may be identified by other failure detection mechanisms. For example, heartbeat messages between that source node and the processing nodes 103 may be monitored. When a failed processing node 103 is identified, it is optionally marked so that new messages are not sent thereto, for example as shown at 294. In addition, the history queue is scanned for identifying pending messages that were sent to the failed processing node 103. As shown at 295, these messages are now resent for processing, for example in an order determined from the oldest message to the newest message based on dependency routing rules. Optionally, the source node 101 goes over the messages, for example from oldest to newest, and rechecks the dependencies of each dependent message, for example based on the respective rules described above. If unsent message can be sent, the source node 101 sends it to the selected processing node and updates the relevant records. In such a manner, dependent messages are handled during the operation of the source node in a manner that assures their dependencies are complied with.

According to some embodiments of the present invention, the set of processing nodes 102 is changed dynamically during the execution of the dependent messages, possibly to adapt to dynamic loads. In such embodiments, the source node is updated, namely synchronized with the new set, for example by receiving notification messages from the processing nodes. Optionally, a protocol is defined between the source node 101 and the processing nodes 103. In such a protocol, each processing node 103 informs the source node 101 about status changing operations. For example, to support a graceful shutdown, the processing node 103 updates the source node 101 before it shuts down. This causes the source node 101 to stop routing messages thereto. Once the processing node 103 completes processing of all the respective pending messages it informs the source node 101 and shuts down. When a new processing node is brought up it let the source node 101 knows when it is ready to process messages.

Optionally, if all the processing nodes 103 fail, messages are accumulated in the pending queue until the queue is full. In case that queue is full, the submission of new messages is either blocked or failed (depending on the policy of the submission method). Optionally, iteratively or sequentially during run time, the source node 101 looks for new processing node(s) 103. Once the source detects a new processing node, it starts sending the pending messages from the queue, so new messages could be submitted again.

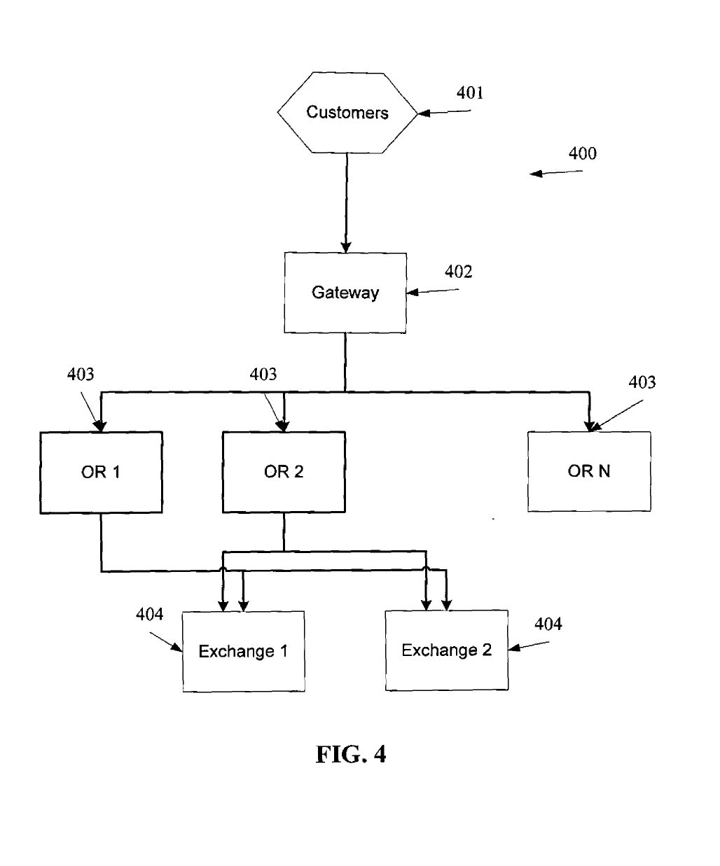

Reference is now made to FIG. 4, which is a schematic illustration 400 depicting exemplary nodes which implement a load balancing scheme pertaining to processing messages of a financial markets trading application, according to some embodiments of the present invention.

In this example, various message dependencies are supported. The financial markets trading application is optionally a simplified securities (stocks, bonds, etc) trading system, for example as used for securities trading, for instance by stockbrokers and investment banks, and/or the like. A client terminal 401 of a customer is used for sending orders, for example buy or sell of stocks orders, to a source node, gateway 402, which forwards the orders to a processing node, an order router (OR) component 403, for example according to a routing module, as described above. The OR 403 processes the orders according to certain business logic to find an exchange (market) 404 to which to send the order and then routs the order to that exchange for execution. In order to reduce the latency, increase the throughput and/or enhance availability, multiple independent ORs 403 are used. ORs 403 may be dynamically added or removed during the day based on the load.

Optionally, the requirement for order processing is that each order is processed only once. Additional requirements may result from the business logic and the way in which orders interact among themselves. These requirements result in the message (order) may be translated to message dependencies, for example as described above.

Examples of such requirements are:
Compound Orders—Orders which include multiple actions, for example different buy and sell actions, with certain rules between the different actions. This is typically referred to as multi-leg orders. For example, a multi-leg order may have the rule of selling stock X and then buying a stock Y. There are a number of variants to the multi-leg rules. For example, the meaning could be Sell X and then Buy Y if and only if X was sold. In most cases multi-leg order processing generates Time-based dependency between the orders. However, they can also generate result-based dependency in case the execution of a certain action depends on the results that were obtained when processing other actions in the same multi-leg order.
Order Updates: updates to an existing order may arrive after an original order was generated. In this case, the OR must see the result from processing the original order in order to be able to process the updates. This use case leads to result-based dependency.
Order Cancel: An order may be canceled. Some users issue orders and then immediately cancel them. In such case the order must be processed before the cancel. This use case leads to time-based dependency.

According to some embodiments of the present invention, destinations are queried to improve message delivery. This ensures that a message is processed only once even if the processing node that handles it fails. For example, when a message m is sent by the source node 101 to processing node A and processing node A processes the message m and sends the result of the processing to destination D. If processing node A fails, before an acknowledge notification is sent to the source node 101, the source node 101 does not receive the acknowledge notification. This acknowledge notification cannot be restored so the source node 101 does not know that message m was already processed by processing node A. In such a case, when the source node 101 detects that processing node A failed, it resends message m to be processed by another processing node.

To assure that a message is delivered only once, the following mechanism can be used:
1. When processing node A sends a message to destination D it adds as metadata message processing information (MPI) to the message. The MPI details the status of incoming messages that processing node A already processed.
2. Destination node D removes MPI from each message and maintains that information. In most cases, the destination node maintains only the last MPI from each processing node and each MPI is small which means that the overhead is small.
3. When the source node detects that processing node A failed, it sends a query to the destination nodes to get any MPI they maintain for processing node A. Based on the MPI the source knows what was the last message that processing node A successfully processed.
4. The source updates the history queue based on the MPI from the destination nodes. That is, it scans the history queue and marks any pending message that was sent to processing node A and received by some destination nodes as processed.

It should be noted that a message that was processed by processing node A but the result was not received by any destination node could be considered as a non-processed message, because no one received the result of the processing.

According to some embodiments of the present invention, each message is assigned with expiration time. For example, message which includes orders may have a limited lifetime after which they are no longer valid. A message may have an expiration time property which means that this message should not be resent after a failure if the timer expired. Optionally, a message without expiration may be flagged with unique value, for example −1, while unique value, for example 0 may mean that the message should never be resent after a failure.

According to some embodiments of the present invention, acknowledge notifications may be delayed. Optionally, the application running on the processing node is able to control the exact point in the execution that the acknowledge notification for a message is sent to the source node. This control may be performed according to messages indicative of reception and/or processing at the destination node. For example, if buy and sell messages are processed according to a dependency rule that defines that Buy Y can be processed immediately after Sell X was processed the acknowledge notification for Sell X may be sent immediately after the message is processed and if the rule is that Buy Y is done only after Sell X has been performed the acknowledge notification can be sent only after an indication is received that Sell X was actually executed (traded) was received from the respective destination.

According to some embodiments of the present invention, result-based dependent messages are marked as processed according to a result cleaning policy. In such embodiments, the results from messages that have been designated to send results back to the source node are maintained by the source node and used for processing future messages that depend on the result. Optionally, when dependent messages are divided to multiple independent and closed sets of messages, the application marks the last dependent message in each set by a special flag. This flag is indicative that new messages do not depend on any message in the current set. Once all the dependent messages in a set are processed, the results may be deleted.

The methods as described above are used in the fabrication of integrated circuit chips.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant systems and methods will be developed and the scope of the term processing node, module, node, and a message is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A computerized method of routing messages sent from a source node to a processing node, comprising:
routing a plurality of messages including a plurality of dependent messages from a source node for processing by any of a group of a plurality of processing nodes, each said message having a weight, each said dependent message being routed while at least one dependency thereof is complied with;
acquiring a plurality of acknowledge notifications to at least some of said plurality of messages from said plurality of processing nodes; and
calculating, at said source node using a processor, a message load of each one of said plurality of processing nodes according to the weight of respective messages of said plurality of messages which are sent thereto and respective acknowledge notifications of said plurality of acknowledge notifications which are sent therefrom;
wherein said routing is performed according to respective said message load.

2. The method of claim 1, further comprising
identifying, using said processor, at least one unprocessed dependent message from of said plurality of dependent messages and a failed processing node of said plurality of processing nodes according to an analysis of said plurality of acknowledge notifications; and
rerouting said at least one unprocessed dependent message for processing by a member of said plurality of processing nodes which is not said failed processing node while at least one dependency thereof is complied with.

3. The method of claim 2, wherein said plurality of messages are forwarded from said plurality of processing nodes to at least one destination; further comprising receiving a plurality of message processing information (MPI) from said at least one destination node to verify a reception of said plurality of messages.

4. The method of claim 2, wherein said rerouting is perform according to respective said expiration time of said at least one unprocessed dependent message.

5. The method of claim 1, wherein said routing is delayed if respective said message load indicates that each of said plurality of processing nodes is overloaded.

6. The method of claim 1, wherein said plurality of processing nodes are plurality of independent processing nodes which are not communicate with one another.

7. The method of claim 1, further comprising dynamically adding or reducing processing nodes from said group according to at least one respective said message load.

8. The method of claim 1, wherein said routing comprises verifying respective said at least one dependency of each said dependent message according to an analysis of said plurality of acknowledge notifications and routing said plurality of dependent messages accordingly.

9. The method of claim 8, wherein each acknowledge notification, from of said plurality of acknowledge notifications, to a first of said plurality of dependent messages comprises a processing result, said verifying comprises verifying said compliance according to said processing result.

10. The method of claim 8, wherein said verifying comprises identifying a desired order at which at least some of said plurality of acknowledge notifications are received.

11. The method of claim 1, wherein said routing comprises for a current message of said plurality of messages, identifying a first of said plurality of processing nodes having a current minimal load in relation to other of said plurality of processing nodes and routing said current message via said first processing node.

12. The method of claim 1, wherein said routing comprises for a current message of said plurality of messages, identifying if all said plurality of processing nodes are overloaded, adding said current message to a pending queue until a new acknowledge notification is received, and routing said current message when not all said plurality of processing nodes being overloaded.

13. A computer readable medium comprising computer executable instructions adapted to perform the method of claim 1.

14. A computerized method of recovering dependent messages sent from a source node to one or more processing nodes, comprising:
routing a plurality of messages including a plurality of dependent messages from a source node having a processor for processing by any of a plurality of processing nodes;
acquiring a plurality of acknowledge notifications each sent in response to the processing of one of said plurality of messages from said plurality of processing nodes;
identifying, using said processor, at least one unprocessed dependent message from of said plurality of messages and a failed processing node of said plurality of processing nodes according to an analysis of said plurality of acknowledge notifications; and
rerouting said at least one unprocessed dependent message for processing by a member of said plurality of processing nodes which is not said failed processing node while at least one dependency thereof is complied with.

15. The method of claim 14, further comprising monitoring a load in each of said plurality of processing nodes by an analysis of said plurality of acknowledge notifications and performing said routing according to said monitoring.

16. The method of claim 14 wherein said plurality of messages are forwarded from said plurality of processing nodes to at least one destination, said identifying comprises sending a request for message processing information (MPI) to said at least one destination node and performing said identifying according to said MPI.

17. The method of claim 14, further comprising monitoring a load in each of said plurality of processing nodes; wherein said routing is delayed if said monitoring indicates that each of said plurality of processing nodes is overloaded.

18. The method of claim 14, further comprising attaching an expiration time indication to each said message; wherein said rerouting is perform according to respective said expiration time of said at least one unprocessed dependent message.

19. A computer readable medium comprising computer executable instructions adapted to perform the method of claim 14.

20. A load balancing system, comprising:
a processor;
a routing module which routes a plurality of messages including a plurality of dependent messages for processing by any of a plurality of processing nodes, each said message having a weight and being transmitted from a source node each said dependent message being routed while at least one dependency thereof is complied with; and
an interface that acquires a plurality of acknowledge notifications, each sent in response to the processing of one of said plurality of messages by one of said plurality of processing nodes;
wherein said routing module calculates a message load of each one of said plurality of processing nodes at said source using said processor according to the weight of respective of said plurality of messages and said plurality of acknowledge notifications;
wherein said routing module performs said routing said plurality of messages according to respective said message load while respective said at least one dependency of each said dependent message is complied with.
